(19) United States
(12) Patent Application Publication
(10) Pub. No.: US 2008/0295654 A1
(43) Pub. Date: Dec. 4, 2008

(54) Torque-Indicating Wrench

(76) Inventor: Yi-Min WU, Taichung City (TW)

Correspondence Address: Dr. BANGER SHIA, 102 Lindencrest Ct., Sugar Land, TX, 77479-5201, US

(21) Appl. No.: 11/754,883

(22) Filed: May 29, 2007

(51) Int. Cl. B25B 23/142

(52) U.S. Cl. 81/467

(57) ABSTRACT

A torque-indicating wrench includes a hollow handle, a head, strain gauge and a threaded bolt. The hollow handle includes an aperture defined therein and a screw hole defined therein opposite to the countersink hole. The head includes a reduced portion. A strain gauge includes a receptacle for receiving the reduced portion of the head and an insert inserted in the hollow handle and formed with an aperture. A threaded bolt is driven in the screw hole through the apertures.

### BACKGROUND OF INVENTION

1. Field of Invention

The present invention relates to a torque-indicating wrench including a handle, a head and a strain gauge firmly provided between the handle and the head so that the torque-indicating wrench is pleasant in look and easy in assembly.

2. Related Prior Art

A torque-indicating wrench includes a handle, a head and a strain gauge provided between the handle and the head. When the wrench is used, the torque loaded therein is observable for the use of the strain gauge. In other words, the torque exerted on a threaded bolt or nut is observable. Thus, an insufficient load in the threaded bolt or nut can be avoided. Such an insufficient load would cause undesired disconnection of things that are supposed to be joined together by the threaded bolt. On the other hand, an excessive load in the threaded bolt or nut can avoided. Such an excessive load would damage the thread of the threaded bolt. Such damage would cause undesired disconnection of the things that are supposed to be joined together by the threaded bolt.

To have the strain gauge work, the strain gauge cannot be tightly attached to the handle. That is, there must be room for movement between the strain gauge and the handle. Conventionally, the handle is hollow for receiving an insert of the strain gauge. A threaded bolt is driven through a screw hole defined in the handle and abutted against the insert of the strain gauge so that the strain gauge is connected to the handle. The connection is however not firm enough so that the strain gauge is often detached from the handle.

The present invention is therefore intended to obviate or at least alleviate the problems encountered in prior art.

### SUMMARY OF INVENTION

According to the present invention, a torque-indicating wrench includes a hollow handle, a head, strain gauge and a threaded bolt. The hollow handle includes an aperture defined therein and a screw hole defined therein opposite to the countersink hole. The head includes a reduced portion. A strain gauge includes a receptacle for receiving the reduced portion of the head and an insert inserted in the hollow handle and formed with an aperture. A threaded bolt is driven in the screw hole through the apertures.

The primary advantage of the wrench according to the present invention is easy and firm assembly.

Other advantages, objectives and features of the present invention will become apparent from the following description referring to the attached drawings.

### BRIEF DESCRIPTION OF DRAWINGS

The present invention will be described via detailed illustration of the preferred embodiment referring to the drawings.

FIG. 1 is a perspective view of a torque-indicating wrench according to the preferred embodiment of the present invention.

FIG. 2 is an exploded view of the torque-indicating wrench shown in FIG. 1.

FIG. 3 is a cross-sectional view of the torque-indicating wrench shown in FIG. 1.

### DETAILED DESCRIPTION OF PREFERRED EMBODIMENT

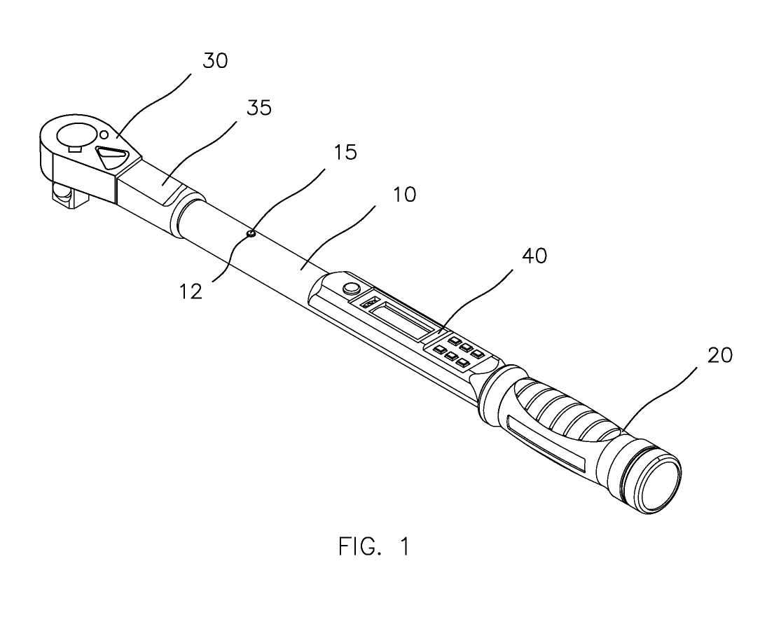

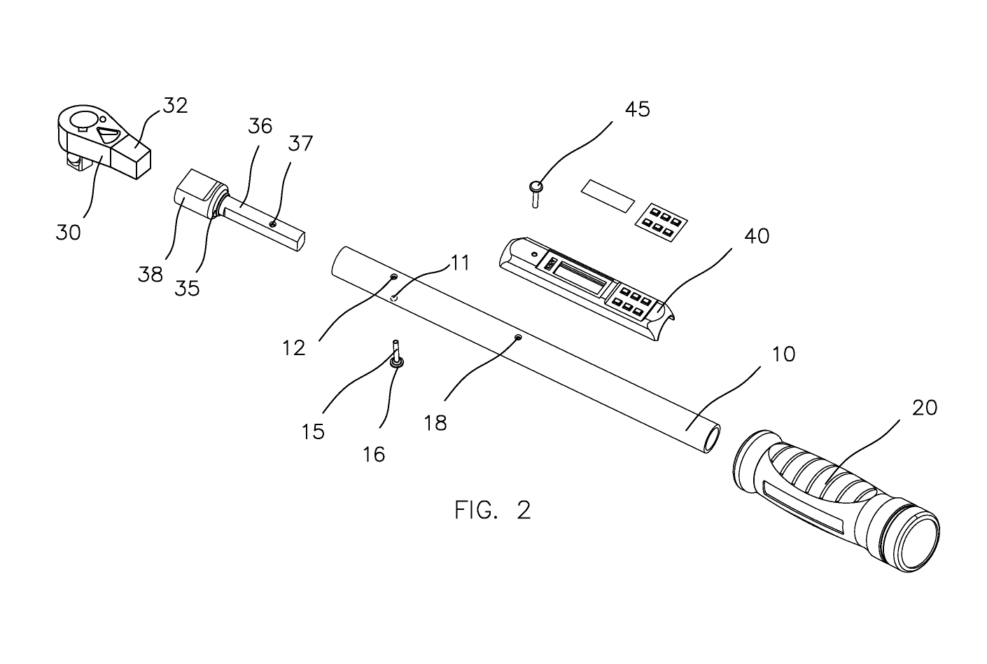

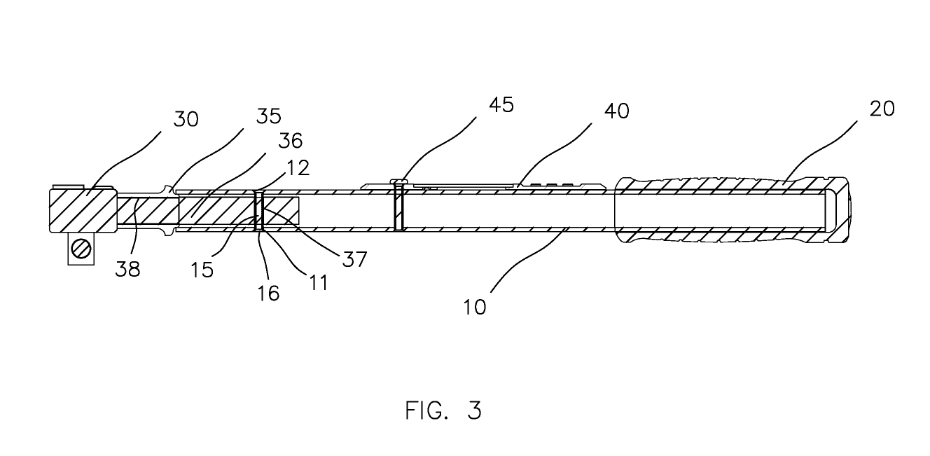

Referring to FIGS. 1 to 3, a torque-indicating wrench includes a hollow handle 10, a grip 20, a head 30, a strain gauge 35 and a processing and monitoring unit 40 according to the preferred embodiment of the present invention.

The hollow handle 10 includes a screw hole 12 defined therein, a countersink hole 11 defined therein opposite to the screw hole 12 and another screw hole 18 defined therein.

The grip 20 is hollow for receiving an end of the hollow handle 10. The grip 20 is made of a soft material to provide a comfort feel to a user s hand. The grip 20 includes a skid-proof external side so that the user can firmly hold the grip 20 and, therefore, the hollow handle 10.

The strain gauge 35 includes an insert 36 at an end and a receptacle 38 at an opposite end. An aperture 37 is defined in the insert 36. The insert 36 is inserted in the handle. A threaded bolt 15 is inserted through the countersink hole 11 and the aperture 37 and driven in the screw hole 12. Thus, the strain gauge 35 is firmly connected to the hollow handle 10. The threaded bolt 15 is formed with a head 16. The head 16 is disposed in the countersink hole 11 so that the wrench looks good.

The space defined in the receptacle 38 is in the form of a conical frustum. The head 30 is formed with a reduced portion 32 shaped like a conical frustum. The reduced portion 32 of the head 30 is fit in the receptacle 38 so that the head 30 is firmly attached to the strain gauge 35. Although not shown in detail, the head 30 includes a selective one-way mechanism so that it can be used to drive a bit in a selected one of two directions. The bit can be a socket or a screwdriver.

A threaded bolt 45 is driven in the screw hole 18 through an aperture defined in the processing and monitoring unit 40. Thus, the processing and monitoring unit 40 is firmly attached to the hollow handle 10. Although not shown, the processing and monitoring unit 40 is electrically connected to the strain gauge 35.

The assembly of the torque-indicating wrench is easy and firm. Moreover, the torque-indicating wrench is aesthetically pleasant.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A torque-indicating wrench comprising:
a hollow handle comprising an aperture defined therein and a screw hole defined therein opposite to the countersink hole;
a head comprising a reduced portion;
a strain gauge comprising a receptacle for receiving the reduced portion of the head and an insert inserted in the hollow handle and formed with an aperture; and
a threaded bolt driven in the screw hole through the apertures.

2. The torque-indicating wrench according to claim 1 wherein the head can be engaged with a screwdriver.

3. The torque-indicating wrench according to claim 1 wherein the head can be engaged with a socket.

4. The torque-indicating wrench according to claim 1 wherein the aperture of the handle is a countersink hole, and the threaded bolt comprises a head disposed in the countersink hole.
